(19) United States
(12) Patent Application Publication
(10) Pub. No.: US 2006/0109497 A1
(43) Pub. Date: May 25, 2006

(54) Systems and methods for facilitating user selection of content from a document for printing

(75) Inventors: Andrew R. Ferlitsch, Tigard, OR (US); James E. Owen, Vancouver, WA (US)

Correspondence Address: MADSON & METCALF, 15 WEST SOUTH TEMPLE, SUITE 900, SALT LAKE CITY, UT, 84101, US

(73) Assignee: Sharp Laboratories of America, Inc.

(21) Appl. No.: 10/994,965

(22) Filed: Nov. 22, 2004

(51) Int. Cl. G06F 15/00

(52) U.S. Cl. 358/1.15; 358/1.13

(57) ABSTRACT

Systems and methods for facilitating user selection of content from a document for printing are disclosed. An exemplary method involves receiving printing instructions for a document from an application. The printing instructions are used to display a soft proof preview to a user of the computing device. The soft proof preview comprises content from the document presented to the user in visual form. The method also involves receiving user input identifying a portion of the content shown in the soft proof preview for printing. A subset of the printing instructions is rendered into printer-ready data. The subset of the printing instructions corresponds to the portion of the content identified by the user.

### TECHNICAL FIELD

The present invention relates generally to printing use of a computer. More specifically, the present invention relates to systems and methods for facilitating user selection of content from a document for printing.

### BACKGROUND

The pagination of the content of a printout is not always easy to see or control from a computer. Some applications do not provide the capability to display a print preview at all, or provide few hints on how the content will be paginated once the document is printed. These kinds of applications will sometimes be referred to herein as non-paginating applications. Examples of non-paginating applications include web browsers (e.g., Microsoft Internet Explorer®), text editors (e.g., Microsoft® Notepad), and the like.

Sometimes a user may only want to print a portion of a document. This may be difficult to accomplish with non-paginating applications. For example, the user may be viewing a document which includes textual data that, when printed, results in dozens or perhaps even hundreds of printed pages. Because non-paginating applications do not have any concept of pages, when the user initiates printing, the user is not able to select a subset of the data to print. Thus, even if the user is only interested in printing a subset of the text, the user is forced to print the entire document, resulting in a waste of paper, ink and time.

Some non-paginating applications provide a page selection from the print menu. However, the pagination information of the content may not be known (i.e., not visible through the application viewer) to the application and the pagination (i.e., splitting into pages) may occur after the printing instructions for the entire content are passed to the printer driver. In this situation, the user must guess how the content will be split into pages and on which page(s) the desired content is located, which may result in the incorrect output.

Additionally, even if the user could correctly identify the page(s) where the content is located, the user's options may still be limited. For example, the user may have to print the entire page, even if the desired content is less than a page. Also, the user may not be able to print discontinuous regions as a single region. In addition, the user may not be able to realign the content to print at the top of a page.

In addition, it may be difficult to exclude sections of content that are not needed. For example, the user may want to print a few summary paragraphs and some supporting graphics, but not print the explanatory pages in-between. Also, the user may want to maintain the integrity of the page numbers, footers and headers, etc., for future reference. While the user can accomplish this by editing the file and creating a new document to complete this task, this would be time consuming and lose the page references from the original document.

In view of the foregoing, benefits may be realized by improved systems and methods for facilitating user selection of content from a document for printing.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 illustrates an exemplary system in which some embodiments may be practiced;

FIG. 2 illustrates an exemplary method that may be performed by one or more embodiments of the repaginating printer driver;

FIG. 3 illustrates an exemplary way that the step of receiving printing instructions from an application may be performed;

FIG. 4 illustrates an exemplary way that the step of displaying a soft proof preview may be performed;

FIG. 5 illustrates an embodiment of the soft proof preview which may be displayed by the repaginating printer driver;

FIG. 6 illustrates another embodiment of the soft proof preview which may be displayed by the repaginating printer driver;

FIG. 7 illustrates another embodiment of the soft proof preview which may be displayed by the repaginating printer driver;

FIG. 8 illustrates an exemplary way that the step of rendering the printing instructions associated with the user-selected content may be performed;

FIG. 9 illustrates another exemplary system in which some embodiments may be practiced;

FIG. 10 illustrates an exemplary method that may be performed by one or more embodiments of the repaginating component; and

FIG. 11 is a block diagram illustrating the major hardware components typically utilized in a computing device.

### DETAILED DESCRIPTION

A method in a computing device is disclosed. The method involves receiving printing instructions for a document from an application. The application may be a non-paginating application or a paginating application. The printing instructions are used to display a soft proof preview to a user of the computing device. The soft proof preview comprises content from the document presented to the user in visual form. User input is received identifying a portion of the content shown in the soft proof preview for printing. The method also involves rendering a subset of the printing instructions into printer-ready data. The subset of the printing instructions corresponds to the portion of the content identified by the user. The method may also involve sending the printer-ready data to a printer.

The content shown in the soft proof preview may be presented in a way that emulates how the content would appear on paper after printing. The soft proof preview may include one or more graphical controls that allow the user to select the portion of the content for printing.

The portion of the content that is identified for printing may include one or more discrete pages. Alternatively, or in addition, the portion of the content that is identified for printing may include one or more individual content items from within a single page or from within multiple pages.

In some embodiments, the method may also involve journaling the printing instructions, thereby creating journaled printing instructions. In such embodiments, displaying the soft proof preview may involve playing back the journaled printing instructions.

The method may involve partitioning the printing instructions into pages having page boundaries. The page boundaries may be identified in the soft proof preview.

The method may also involve performing a scale transformation, a rotation transformation, or a color transformation on selected content items from the document. The method may also involve adding context information to the printer-ready data.

In some embodiments, the content from the document is displayed in the soft proof preview without pagination. Alternatively, or in addition, the soft proof preview may comprise a movable page window. In such embodiments, receiving the user input may involve allowing the user to position the movable page window. The dimensions of the movable page window may be changed by the user.

In some embodiments, the soft proof preview may comprise a content window for displaying the content from the document. The soft proof preview may also comprise a print preview window. The soft proof preview may also comprise a copy/paste control. The copy/paste control allows the user to copy one or more individual content items from the content window into the print preview window.

Another embodiment of a method in a computing device is also disclosed. The method involves receiving printing instructions for a document from an application. User input is received identifying a portion of content from the document for printing. The portion of the content comprises one or more individual content items from within a single page or from within multiple pages. The method also involves rendering a subset of the printing instructions into printer-ready data. The subset of the printing instructions corresponds to the portion of the content identified by the user.

Another embodiment of a method in a computing device is also disclosed. The method involves receiving printer-ready data corresponding to a document from a printer driver. The printer-ready data is used to display a soft proof preview to a user of the computing device. The soft proof preview comprises content from the document presented to the user in visual form. The method also involves receiving user input identifying a portion of the content shown in the soft proof preview for printing. The method also involves sending a subset of the printer-ready data to a printer. The subset of the printer-ready data corresponds to the portion of the identified by the user.

A computing device is also disclosed. The computing device comprises a processor and memory in electronic communication with the processor. Instructions are stored in the memory. The instructions are executable to implement a method that involves receiving printing instructions for a document from an application. The printing instructions are used to display a soft proof preview to a user of the computing device. The soft proof preview comprises content from the document presented to the user in visual form. User input is received identifying a portion of the content shown in the soft proof preview for printing. The method also involves rendering a subset of the printing instructions into printer-ready data. The subset of the printing instructions corresponds to the portion of the content identified by the user.

A computer-readable medium is also disclosed. The computer-readable medium comprises executable instructions for implementing a method in a computing device. The method involves receiving printing instructions for a document from an application. The printing instructions are used to display a soft proof preview to a user of the computing device. The soft proof preview comprises content from the document presented to the user in visual form. User input is received identifying a portion of the content shown in the soft proof preview for printing. The method also involves rendering a subset of the printing instructions into printer-ready data. The subset of the printing instructions corresponds to the portion of the content identified by the user.

Various embodiments of the invention are now described with reference to the Figures, where like reference numbers indicate identical or functionally similar elements. It will be readily understood that the embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

Several aspects of the embodiments described herein will be illustrated as software components stored in a computing device. The term software component, as used herein, refers to any collection of one or more computer-executable instructions stored in a memory device. A software component may comprise a single instruction, or many instructions. The instructions may be organized as a routine, program, object, or the like. Moreover, the instructions within a software component may be distributed over different code segments, different programs, different locations of the same memory device, and/or different memory devices.

The order of the steps or actions of the methods described in connection with the embodiments disclosed herein may be changed by those skilled in the art without departing from the scope of the present invention. Thus, any order in the Figures or detailed description is for illustrative purposes only and is not meant to imply a required order.

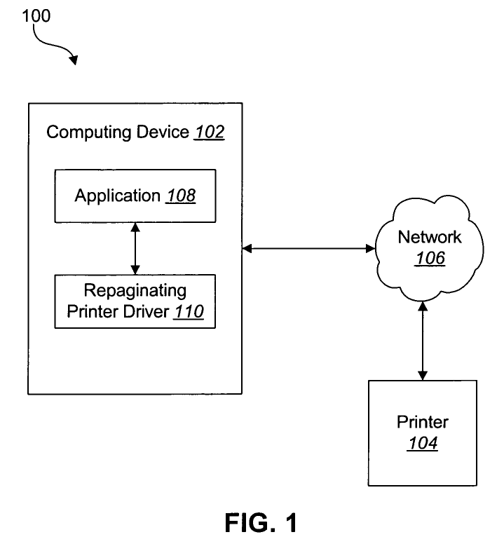

FIG. 1 illustrates an exemplary system 100 in which some embodiments may be practiced. The system 100 includes a computing device 102 and a printer 104. The computing device 102 is in electronic communication with the printer 104. In some embodiments, communication between the computing device 102 and the printer 104 may occur via one or more computer networks 106.

The computing device 102 includes an application 108. The application 108 is a software component, as that term is defined above. In some embodiments, the application 108 may be a non-paginating application 108, i.e., an application 108 that does not provide any indication of how the content of a document will be paginated once the document is printed. Examples of non-paginating applications 108 include web browsers (e.g., Microsoft Internet Explorer®), text editors (e.g., Microsoft® Notepad), and the like. In other embodiments, the application 108 may be a paginating application 108, such as a word processor, spreadsheet, or the like.

The computing device 102 also includes a printer driver 110. The printer driver 110 is a software component, as that term is defined above. Like known printer drivers, the printer driver 110 acts as an interface between the application 108 and the printer 104. In addition, the printer driver 110 also allows the user to perform certain repagination operations on documents that are being sent to the printer 104. Thus, the printer driver 110 will sometimes be referred to herein as a repaginating printer driver 110. Various embodiments of the repaginating printer driver 110 and examples of repagination operations that the driver 110 supports will be described below.

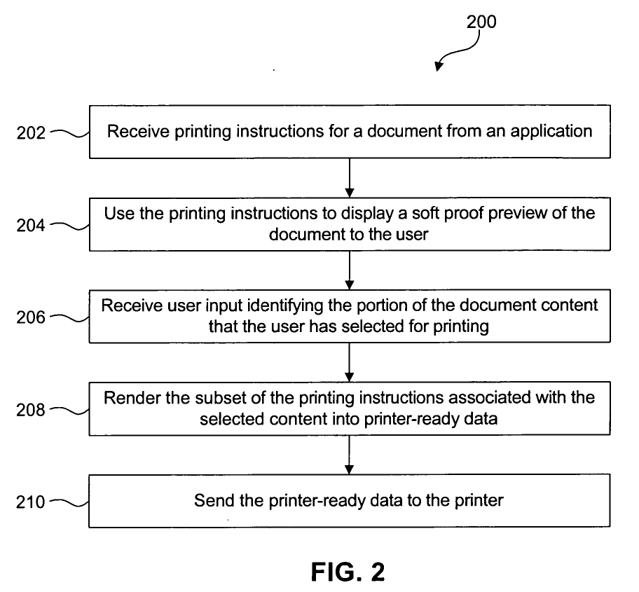

FIG. 2 illustrates an exemplary method 200 that may be performed by one or more embodiments of the repaginating printer driver 110. The method 200 begins when printing instructions for a document are received 202 from the application 108.

The printing instructions are used to display 204 a soft proof preview of the document to the user. The soft proof preview comprises at least some of the content from the document, such as text, images, etc. The document content is presented to the user in visual form. In some embodiments the content of the document is displayed in a way that emulates how the content would appear on paper after printing. In such embodiments the soft proof preview can be thought of as a kind of “print preview.”

The user selects a portion of the content shown in the soft proof preview for printing. The user may be allowed to select one or more discrete pages for printing (e.g., pages one and two out of a five-page document). Alternatively, or in addition, the user may be allowed to select individual content items (e.g., an image, a single paragraph, etc.) from within one or more pages. In some embodiments, the soft proof preview contains various graphical controls (e.g., buttons, scroll bars, pull-down menus, sliders, etc.) that allow the user to select the content from the document that the user desires to print. The driver 110 receives 206 user input identifying the portion of the document content that the user has selected for printing.

Once the user has selected the portion of the document that he or she desires to print, the user may initiate the printing of the selected content. The repaginating driver 110 then renders 208 the subset of the printing instructions associated with the selected content into printer-ready data. The printer-ready data is in a format that the printer 104 can understand. For example, the printer-ready data may be formatted according to a page description language, such as Printer Control Language, Adobe PostScript®, etc. Alternatively, or in addition, the printer-ready data may comprise one or more raster images (i.e., bitmaps). The printer-ready data is then sent 210 to the printer 104.

The terms printer and printer driver are used broadly here. These terms can refer to a device and operation which produces a hardcopy output (print), transmission of a facsimile (fax), conversion to another electronic format (convert), archiving in a storage (file), posting on a web site (publish), and insertion into another imaging job (job build), such as a copy job.

As indicated above, the method 200 shown in FIG. 2 involves displaying a soft proof preview. However, in some embodiments the repaginating driver 110 allows the user to perform repagination operations without displaying a soft proof preview. In such embodiments, the user inputs identifying information about the content that he or she would like to print by some means other than the soft print preview (e.g., a dialog box). These kinds of embodiments may be useful in situations where the user is likely to know the content that he or she would like to print without the need to see the content in visual form.

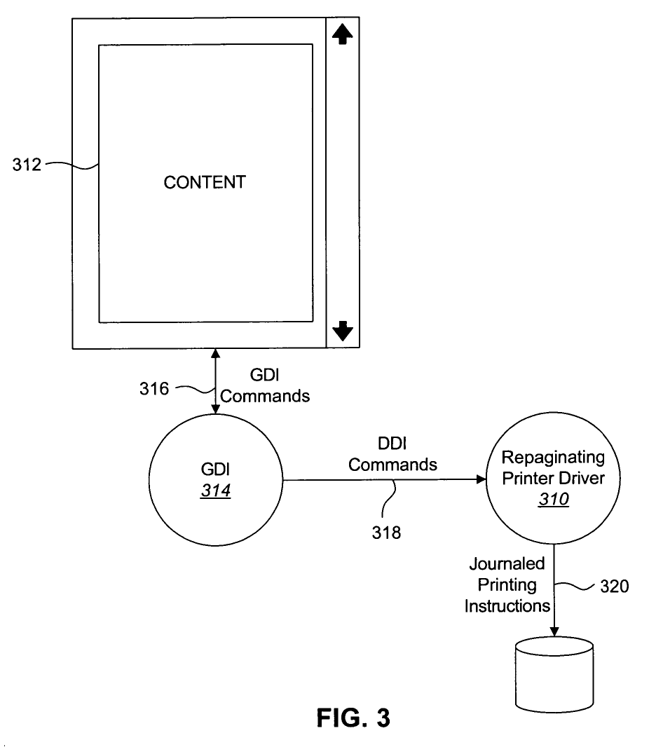

FIG. 3 illustrates an exemplary way that the step of receiving 202 printing instructions from an application 108 may be performed. The application 108 generates a document 312 which comprises certain content. The user initiates printing of the document 312 by selecting an appropriate menu selection from the application 108 (e.g., the File→Print menu selection).

In embodiments that are practiced in a Microsoft Windows® environment, the application 108 then converts the content of the document 312 into printing instructions that are compatible with the graphics device interface (GDI) 314, i.e., a series of GDI commands 316. The GDI 314 then repackages these GDI commands 316 to conform to the driver's 310 device driver interface (DDI). These DDI commands 318 are then provided to the driver 310.

In the illustrated embodiment, the driver 310 journals the printing instructions 320 that are received from the application 108. This involves saving the printing instructions 320 to memory (e.g., to a file or RAM) for subsequent playback. The printing instructions 320 may be saved in a particular format, such as enhanced metafile (EMF) by Microsoft, printer metafile (PMF) by Sharp, and so forth. (It should be noted that the EMF format referred to here may not be the same EMF that the print processor in a Microsoft Windows® environment would receive. In this context, the EMF file may include DDI commands 318.)

In some embodiments, the application 108 sends the printing instructions 320 for the entire document 312 to the driver 310. However, in some other embodiments, the application 108 may send the printing instructions 320 for just a portion of the document 312 to the driver 310. For example, the application 108 may allow the user to select a subset of the pages of the document 312 for printing. If this occurs, the application 108 may pass the printing instructions 320 for just the selected pages to the driver 310.

For example, suppose the user, via a dialog box displayed by the application 108, selects all the pages of a document 312 for printing. In this situation, the application 108 may send all of the printing instructions 320 to the driver 310. However, if the user were to select page one only, the application 108 may send printing instructions 320 for page one (but not for the remaining pages) of the document 312 to the driver 310.

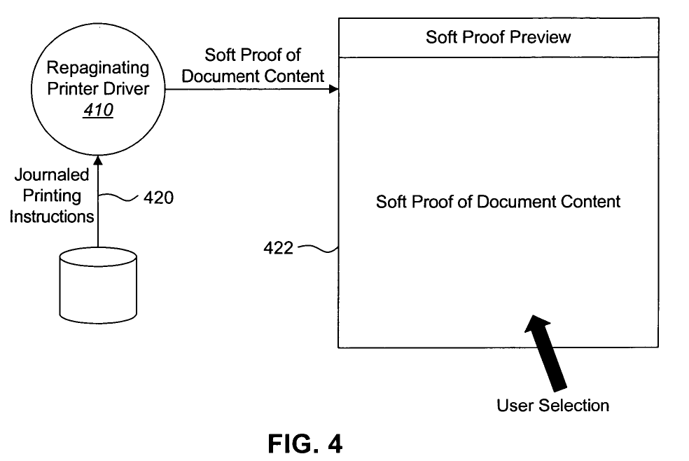

FIG. 4 illustrates an exemplary way that the step of displaying 204 a soft proof preview 422 may be performed. In some embodiments where the printing instructions 420 are journaled, the driver 410 receives and journals all of the printing instructions 420 from the application 108 before the soft proof preview 422 is displayed. More specifically, after the driver 410 has received and journaled all of the printing instructions 420 for the document 312, the driver 410 displays the soft proof preview 422 by playing back the journaled printing instructions 420. In embodiments that are practiced in a Microsoft Windows® environment, the journaled printing instructions 420 may be played back to the device context associated with the application 108 window. The user may then select some portion of the content shown in the soft proof preview 422 for printing.

In some embodiments, the printing instructions for the document 312 are not journaled first. Instead, an initial subset of the printing instructions are received and buffered. A soft proof preview 422 is displayed which shows the portion of the document 312 corresponding to the received printing instructions. The user is allowed to select any of the content displayed in the soft proof preview 422 for printing. As additional printing instructions are received, the soft proof preview 422 is updated to include the additional content.

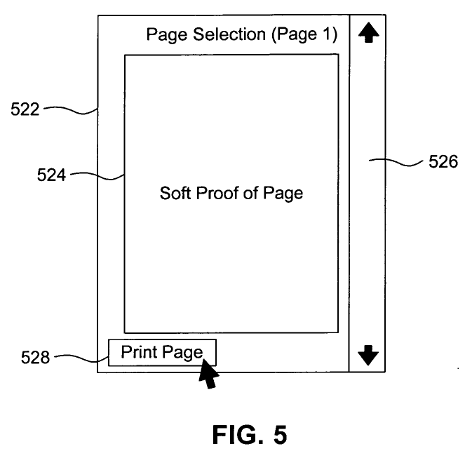

FIG. 5 illustrates an embodiment of the soft proof preview 522 which may be displayed by the repaginating printer driver 110. The soft proof preview 522 includes a window 524 for displaying the content of the document 312. This window 524 will sometimes be referred to herein as a content window 524.

There are a variety of ways that the content of the document 312 may be displayed in the content window 524. In some embodiments, the repaginating driver 110 partitions the printing instructions 320 into pages. The page dimensions may be specific to a selected paper size for a specific printer or for an abstract printer. The boundaries of the pages may be identified in the soft proof preview 522. For example, a separator (such as a line) may be included between different pages. Alternatively, the soft proof preview 522 may show only one page at a time. Alternatively still, the soft proof preview 522 may display multiple pages at a time as thumbnail images. In such embodiments, the user may zoom in on the content of a specific page by clicking on the corresponding thumbnail image.

In some other embodiments, the content of the document 312 may be displayed without any pagination. Where the content is displayed without pagination, the width of the content may be determined with respect to a selected paper size for a specific printer or for an abstract printer.

The embodiment of the soft proof preview 522 shown in FIG. 5 includes a scroll bar 526 and a “Print Page” button 528. The scroll bar 526 may be used to scroll through the pages of the document 312, as displayed in the content window 524. When a desired page is displayed in the content window 524, the user may initiate printing of this page by clicking on the “Print Page” button 528.

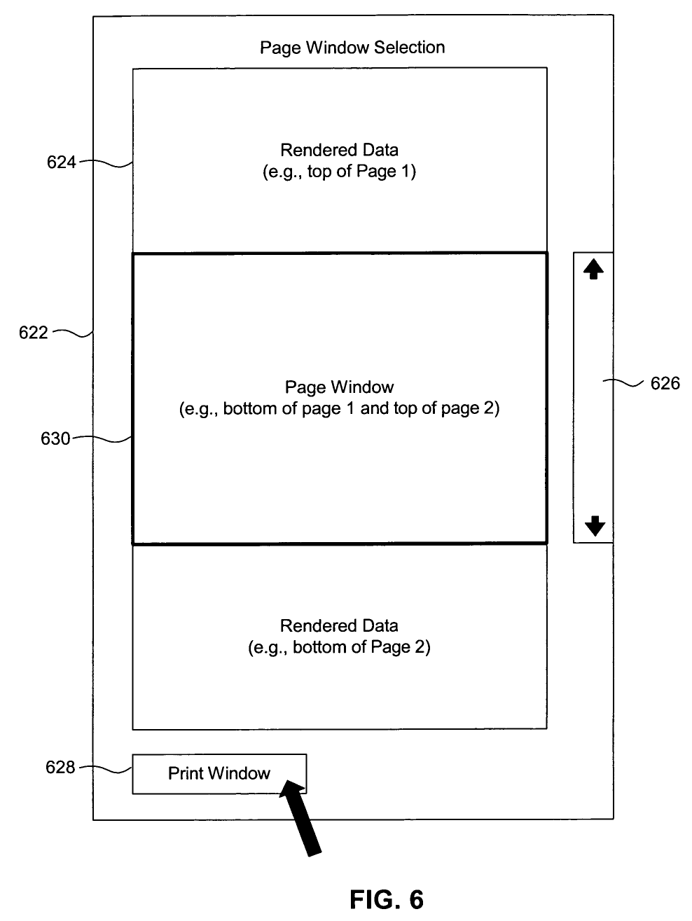

FIG. 6 illustrates another embodiment of the soft proof preview 622 which may be displayed by the repaginating printer driver 110. As before, the soft proof preview 622 includes a content window 624 and a scroll bar 626.

The embodiment of the soft proof preview 622 shown in FIG. 6 also includes a movable page window 630. The user is allowed to move this window 630 to select a region of content and its position in the window 630. The dimensions of the movable page window 630 may initially be set to the selected paper size for a specific printer or an abstract printer. In some embodiments, the dimensions of the movable page window 630 may be changed by the user.

A movable page window 630 may be advantageous in situations where the user wants to print a portion of a document that spans across multiple pages. For example, suppose that the user wants to print a portion of a document that begins at the bottom of page one and ends at the top of page two. The user may position the movable page window 630 so that the top of the movable page window 630 is located at the bottom of page one, and the bottom of the movable page window 630 is located at the top of page two.

The soft proof preview 422 also includes a “Print Window” button 628. Once the desired content is positioned inside the movable page window 630, the user may click on the “Print Window” button 628 in order to initiate printing of the selected content. When the user clicks on the “Print Window” button 628, the repaginating driver 110 identifies the content that is inside the movable page window 630. The printing instructions corresponding to this portion of the document are converted into printer-ready data and sent to the printer 104.

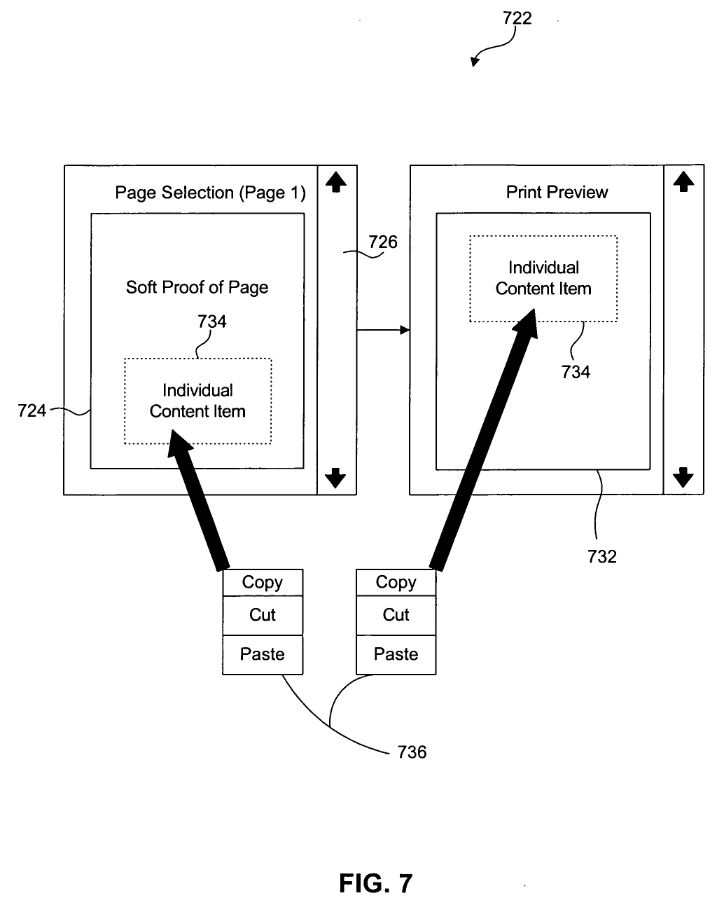

FIG. 7 illustrates another embodiment of the soft proof preview 722 which may be displayed by the repaginating printer driver 110. As before, the soft proof preview 722 includes a content window 724 with a scroll bar 726.

The embodiment of the soft proof preview 722 shown in FIG. 7 also includes a print preview window 732. The print preview window 732 shows how the selected portions of content from the document will appear when printed. The soft proof preview 722 also includes a copy/paste control 736. The copy/paste control 736 allows the user to copy individual content items 734 from the content window 724 into the print preview window 732. The individual content items 734 may be images, text, etc.

The user may arrange the individual content items 734 in the print preview window 732 differently than they are arranged in the content window 724. For example, suppose that a content item 734 is located toward the bottom of a page in the content window 724. The user may position this content item 734 toward the top of the page in the print preview window 732. The user may also make other alterations to the individual content items 734, such as scale, rotation and color transformations.

The soft proof preview 722 may also include one or more graphical controls that allow the user to initiate printing. Once the user has copied the desired content from the content window 724 into the print preview window 732, the user may initiate printing of this content via these graphical controls.

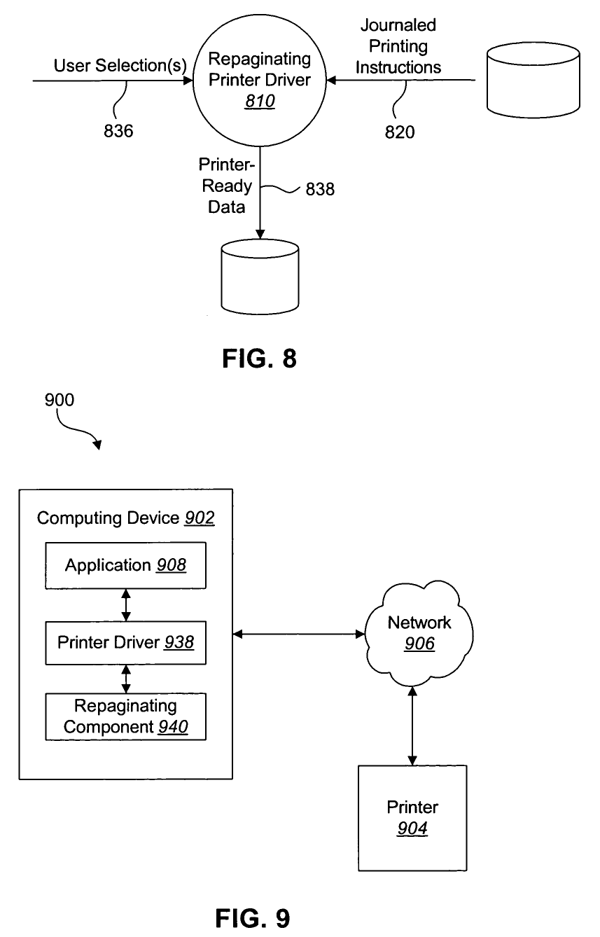

FIG. 8 illustrates an exemplary way that the step of rendering 208 the printing instructions associated with the user-selected content may be performed. The driver 810 receives the user's selection 836 of content from the document 312 that the user desires to print. The driver 810 identifies the printing instructions 820 (which may be journaled) associated with the user-selected content, and renders these printing instructions 820 into printer-ready data 838. The printer-ready data 838 may be immediately sent to the printer 104, spooled for subsequent transmission to the printer 104 (which may be known at the time of selection or selected when de-spooled), or saved without spooling (e.g., printed to a file).

In some embodiments, the driver 810 may add context information to the printer-ready data 838. The context information may provide information about the location of the selected content in the original document 312. For example, suppose that the user selected two sections from a 50-page document for printing. The first section is taken from the middle of page three, and the second section is taken from the bottom of page six. The driver 810 may insert the following context information (which is italicized) to the printer-ready data:

Document: xyz report.doc
Printed by: jowen On 2/20/04
2 selections extracted from pages 3, 6
Selection 1: Page 3 middle:
As the previous paragraph states,
...
Selection 2: Page 6 bottom:
As the diagram below shows
...

FIG. 9 illustrates another exemplary system 900 in which some embodiments may be practiced. The system 900 includes a computing device 902 and a printer 904. The computing device 902 is in electronic communication with the printer 904, possibly via one or more computer networks 906. The computing device 902 includes at least one application 908, which may be a non-paginating application 908 or a paginating application 908. The computing device 902 also includes a standard printer driver 938.

The computing device 902 also includes a repaginating component 940. The repaginating component 940 is a software component, as that term is defined above. Like the repaginating printer driver 110 described previously, the repaginating component 940 allows the user to perform repagination operations on documents that are being sent to the printer 904. However, the repaginating component 940 is not part of the printer driver 938, and therefore may be added to a system that already includes a standard printer driver 938. For example, in embodiments that are practiced in a Microsoft Windows® environment, the print processor may be configured to serve as the repaginating component 940.

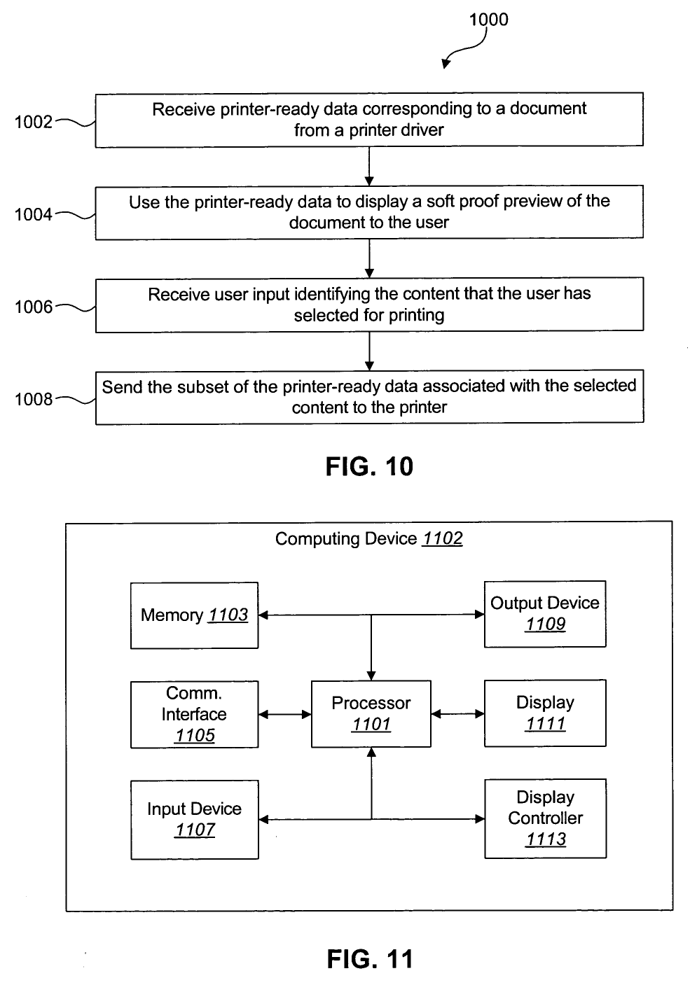

FIG. 10 illustrates an exemplary method 1000 that may be performed by one or more embodiments of the repaginating component 940. The method 1000 begins when printer-ready data corresponding to a document is received 1002 from the printer driver 938.

The printer-ready data is used to display 1004 a soft proof preview of the document to the user. In some embodiments, this may involve converting the printer-ready data into an appropriate display format. For example, in embodiments that are practiced in a Microsoft Windows® environment, the printer-ready data may be converted back into a series of GDI commands. Alternatively, an appropriate interpreter may be used to display the printer-ready data. For example, where the printer-ready data is in Adobe PostScript® format, an interpreter for the PostScript® language (e.g., Ghostview) may be used to display the printer-ready data.

The user selects a portion of the content in the document for printing. The repaginating component 940 receives 1006 user input identifying the content that the user has selected for printing. As before, the soft proof preview may include various graphical controls that allow the user to select the content in the document that the user desires to print.

Once the user has selected the portion of the document that he or she desires to print, the user may initiate the printing of the selected content. In response, the repaginating component 940 then sends 1008 the subset of the printer-ready data associated with the selected content to the printer 104.

The embodiments described above have involved documents being sent to a printer. Other embodiments include other imaging operations which render application content (i.e., soft-copy) or physical document content (i.e., hard-copy) to/from an imaging device, such as fax, scan, copy, document management (e.g., document archive/retrieval, manipulation and transfer), displaying to a monitor device, repaginating and/or converting to another application/document format, displaying to or receiving from an electronic whiteboard or tablet PC, and so forth.

Some of the embodiments disclosed herein have been described in the context of a Microsoft Windows® environment. However, embodiments may be practiced in computing devices that are running other operating systems, such as Apple Macintosh®, Linux, Unix System V, BSD Unix, OSF Unix, IBM MVS, IBM AS/400, and so forth.

FIG. 11 is a block diagram illustrating the major hardware components typically utilized in a computing device 1102. The illustrated components may be located within the same physical structure or in separate housings or structures.

The computing device 1102 includes a processor 1101 and memory 1103. The processor 1101 controls the operation of the computing device 102 and may be embodied as a microprocessor, a microcontroller, a digital signal processor (DSP) or other device known in the art. The processor 1101 typically performs logical and arithmetic operations based on program instructions stored within the memory 1103.

As used herein, the term memory 1103 is broadly defined as any electronic component capable of storing electronic information, and may be embodied as read only memory (ROM), random access memory (RAM), magnetic disk storage media, optical storage media, flash memory devices in RAM, on-board memory included with the processor 1101, EPROM memory, EEPROM memory, registers, etc. The memory 1103 typically stores program instructions and other types of data. The program instructions may be executed by the processor 1101 to implement some or all of the methods disclosed herein.

The computing device 1102 typically also includes one or more communication interfaces 1105 for communicating with other electronic devices. The communication interfaces 1105 may be based on wired communication technology, wireless communication technology, or both. Examples of different types of communication interfaces 1105 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computing device 1102 typically also includes one or more input devices 1107 and one or more output devices 1109. Examples of different kinds of input devices 1107 include a keyboard, mouse, microphone, remote control device, button, joystick, trackball, touchpad, lightpen, etc. Examples of different kinds of output devices 1109 include a speaker, printer, etc. One specific type of output device which is typically included in a computer system is a display device 1111. Display devices 1111 used with embodiments disclosed herein may utilize any suitable image projection technology, such as a cathode ray tube (CRT), liquid crystal display (LCD), light-emitting diode (LED), gas plasma, electroluminescence, or the like. A display controller 1113 may also be provided, for converting data stored in the memory 1103 into text, graphics, and/or moving images (as appropriate) shown on the display device 1111.

Of course, FIG. 11 illustrates only one possible configuration of a computing device 1102. Those skilled in the art will recognize that various other architectures and components may be utilized. In addition, various standard components are not illustrated in order to avoid obscuring aspects of the invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. In a computing device, a method comprising:
receiving printing instructions for a document from an application;
using the printing instructions to display a soft proof preview to a user of the computing device, wherein the soft proof preview comprises content from the document presented to the user in visual form;
receiving user input identifying a portion of the content shown in the soft proof preview for printing; and
rendering a subset of the printing instructions into printer-ready data, wherein the subset of the printing instructions corresponds to the portion of the content identified by the user.

2. The method of claim 1, further comprising sending the printer-ready data to a printer.

3. The method of claim 1, wherein the application is a non-paginating application.

4. The method of claim 1, wherein the application is a paginating application.

5. The method of claim 1, wherein the content shown in the soft proof preview is presented in a way that emulates how the content would appear on paper after printing.

6. The method of claim 1, wherein the portion of the content that is identified for printing comprises one or more discrete pages.

7. The method of claim 1, wherein the portion of the content that is identified for printing comprises one or more individual content items.

8. The method of claim 1, wherein the soft proof preview comprises one or more graphical controls that allow the user to select the portion of the content for printing.

9. The method of claim 1, further comprising journaling the printing instructions, thereby creating journaled printing instructions.

10. The method of claim 9, wherein displaying the soft proof preview comprises playing back the journaled printing instructions.

11. The method of claim 1, further comprising partitioning the printing instructions into pages having page boundaries, and wherein the page boundaries are identified in the soft proof preview.

12. The method of claim 1, wherein the content from the document is displayed in the soft proof preview without pagination.

13. The method of claim 1, wherein the soft proof preview comprises a movable page window, and wherein receiving the user input comprises allowing the user to position the movable page window.

14. The method of claim 13, wherein dimensions of the movable page window may be changed by the user.

15. The method of claim 1, wherein the soft proof preview further comprises:
a content window for displaying the content from the document;
a print preview window; and
a copy/paste control that allows the user to copy one or more individual content items from the content window into the print preview window.

16. The method of claim 1, further comprising performing a scale transformation, a rotation transformation, or a color transformation on selected content items from the document.

17. The method of claim 1, further comprising adding context information to the printer-ready data.

18. In a computing device, a method comprising:
receiving printing instructions for a document from an application;
receiving user input identifying a portion of content from the document for printing, wherein the portion of the content comprises one or more individual content items; and
rendering a subset of the printing instructions into printer-ready data, wherein the subset of the printing instructions corresponds to the portion of the content identified by the user.

19. In a computing device, a method comprising:
receiving printer-ready data corresponding to a document from a printer driver;
using the printer-ready data to display a soft proof preview to a user of the computing device, wherein the soft proof preview comprises content from the document presented to the user in visual form;
receiving user input identifying a portion of the content shown in the soft proof preview for printing; and
sending a subset of the printer-ready data to a printer, wherein the subset of the printer-ready data corresponds to the portion of the content identified by the user.

20. A computing device, comprising:
a processor;
memory in electronic communication with the processor;
instructions stored in the memory, the instructions being executable to implement a method comprising:
receiving printing instructions for a document from an application;
using the printing instructions to display a soft proof preview to a user of the computing device, wherein the soft proof preview comprises content from the document presented to the user in visual form;
receiving user input identifying a portion of the content shown in the soft proof preview for printing; and
rendering a subset of the printing instructions into printer-ready data, wherein the subset of the printing instructions corresponds to the portion of the content identified by the user.

21. The computing device of claim 20, wherein the application is a non-paginating application.

22. The computing device of claim 20, wherein the application is a paginating application.

23. The computing device of claim 20, wherein the soft proof preview comprises a movable page window, and wherein receiving the user input comprises allowing the user to position the movable page window.

24. The computing device of claim 20, wherein the soft proof preview further comprises:
a content window for displaying the content from the document;
a print preview window; and
a copy/paste control that allows the user to copy one or more individual content items from the content window into the print preview window.

25. The computing device of claim 20, wherein the method further comprises performing a scale transformation, a rotation transformation, or a color transformation on selected content items from the document.

26. A computer-readable medium comprising executable instructions for implementing a method in a computing device, the method comprising:
receiving printing instructions for a document from an application;
using the printing instructions to display a soft proof preview to a user of the computing device, wherein the soft proof preview comprises content from the document presented to the user in visual form;
receiving user input identifying a portion of the content shown in the soft proof preview for printing; and
rendering a subset of the printing instructions into printer-ready data, wherein the subset of the printing instructions corresponds to the portion of the content identified by the user.

27. The computer-readable medium of claim 26, wherein the application is a non-paginating application.

28. The computer-readable medium of claim 26, wherein the application is a paginating application.

29. The computer-readable medium of claim 26, wherein the soft proof preview comprises a movable page window, and wherein receiving the user input comprises allowing the user to position the movable page window.

30. The computer-readable medium of claim 26, wherein the soft proof preview further comprises:
a content window for displaying the content from the document;
a print preview window; and
a copy/paste control that allows the user to copy one or more individual content items from the content window into the print preview window.

31. The computer-readable medium of claim 26, wherein the method further comprises performing a scale transformation, a rotation transformation, or a color transformation on selected content items from the document.
